(19) United States
(12) Patent Application Publication
(10) Pub. No.: US 2012/0111875 A1
(43) Pub. Date: May 10, 2012

(54) APPARATUS AND METHOD FOR BALANCING AND HOLDING AN OBJECT

(76) Inventor: Craig Johnson, Tooele, UT (US)

(21) Appl. No.: 12/939,913

(22) Filed: Nov. 4, 2010

(51) Int. Cl. B65D 25/20; F16M 13/00; B23P 17/04

(52) U.S. Cl. 220/629; 29/428; 248/346.06

(57) ABSTRACT

An apparatus and method are disclosed for balancing and holding an object. The apparatus may include a base, at least one support arm, and a basket. The base may include a plane and a wall. The basket may be attached to the support arm such that the basket may rotate on the support arm and balance such that the bottom and open end of the basket are horizontal.

### FIELD

This invention relates to drink holders and more particularly relates to drink holders for outdoor use and recreational use.

### BACKGROUND

Outdoor activities and sporting activities have always been popular among people of all different groups. People enjoy barbeques, outdoor concerts, camping, boating, fishing, and all other kinds of outdoor activities and sporting activities.

Often times, food and social events accompany these outdoor activities. The food at sporting events and concerts ranges from ethnic foods, to traditional hotdogs and hamburgers, to soft drinks and alcohol. Often times consumption of this food takes place on location with the activity. For example, people often bring food to outdoor concerts so that they can eat while they listen to music and enjoy each other's company. In another example, people often bring food and drinks with them while they are on a boating outing or on a road trip in an automobile. The food can be solely for enjoyment or sometimes a necessary element of the activity, depending on the climate conditions and the activity.

Many times consuming food in these arenas takes place outside of the reach of a typical dinner table or picnic table. This often means the people will sit on the ground, on camping chairs, on the beach, in an automobile seat during automobile motion, or in the boat while the boat is in motion, depending on the activity. Many times, this means that meal plates and cups are precariously placed on laps and held in hands while people try to eat. This often makes for uncomfortable eating, spilled drinks, and spilled plates. For example, outdoor concert venues often include a grassy area that is sloped so that all attendees can view the concert performers. Setting a plate of food or a drink on the sloped surface often results in drinks that are off balance and plates that are off balance. This can result in spilled and wasted food and drink.

What is needed is a mechanism that would allow for balancing and holding of objects regardless of the incline or slope of the subsurface upon which the objects are to be placed or the motion of the subsurface upon which the objects are to be placed.

### SUMMARY

From the foregoing discussion, it should be apparent that a need exists for an apparatus and method to balance and hold an object. Beneficially, such an apparatus and method would balance and hold an object in a horizontal fashion regardless of the slope of the subsurface or the movement of the subsurface.

The present invention has been developed in response to the present state of the art, and in particular, in response to the problems and needs in the art that have not yet been fully solved by currently available technology. Accordingly, the present invention has been developed to provide an apparatus and method for balancing and holding an object that overcome many or all of the above-discussed shortcomings in the art.

The apparatus to balance and hold an object is provided with a plurality of parts configured to functionally execute the necessary steps of balancing and holding an object. These parts in the described embodiments include a base, at least one support arm, and a basket.

The apparatus, in one embodiment, contains a base, at least one support arm, and a basket. In one embodiment, the base is configured to support the apparatus. In one embodiment, the base includes a plane and at least one wall. In another embodiment, the at least one support arm is rotatably connected to the base. In yet another embodiment, the basket is rotatably connected to the at least one support arm.

In one embodiment, the basket contains a face, a bottom, and an open end. In another embodiment, the basket is configured to rotate on the at least one support arm such that the bottom and open end are horizontal.

In one embodiment, the apparatus also includes at least one second support arm rotatably connected to the at least one support arm. In another embodiment, the apparatus includes an anchor connected to the base. In one embodiment, the anchor is configured to secure the apparatus to a subsurface. In another embodiment, the anchor is a spike which is configured to penetrate the subsurface. In yet another embodiment, the base contains two or more anchors. In a further embodiment, the anchor is rotatably connected to the base. In another embodiment, the base contains a locking chamber which is configured to hold the anchor when the anchor is rotated toward the base. In another embodiment, the base contains ribs which are configured to grip to the subsurface.

In another embodiment, the basket is has a semi-transparent face and a semi-transparent bottom. In one embodiment, the semi-transparent face and semi-transparent bottom are made of a mesh material. In one embodiment, the support arm and the basket can collapse into and substantially flatten against the base.

In one embodiment, the wall of the base contains a track. In one embodiment, the second support arm is connected to a bar which is slidably disposed within the track such that the bar can lock the apparatus in an upright position when the bar is at a near end of the track. The bar can also hold the apparatus in a collapsed position when the bar is at a far end of the track.

In one embodiment, the apparatus also contains a shape-keeping ring which is disposed on a top portion of the basket. In another embodiment, the shape-keeping ring is configured to maintain a circular shape of the top portion of the basket.

The apparatus, in one embodiment, contains a base, two support arms, two second support arms, and a basket. In one embodiment, the base is configured to support the apparatus. In another embodiment, the base contains a plane and at least one wall. In one embodiment, the wall also contains a track.

In one embodiment, the two support arms are rotatably connected to opposite ends of the base. In another embodiment, the two second support arms are rotatably connected to the support arms and are also connected to opposite distal ends of a bar. In one embodiment, the bar is disposed within the track and slides within the track.

In one embodiment, the basket is connected to distal ends of the support arms. The basket may include, in one embodiment, a face and a bottom. In one embodiment, the basket is configured to rotate on the support arms such that the bottom is horizontal. In another embodiment, the basket and the support arms are collapsible onto the base by sliding the bar to a far end of the track.

In one embodiment, the base contains a vacancy. In another embodiment, the base, support arms, and the second support arms are made of molded plastic. In another embodiment, the basket is cylindrical and is configured to contain a lower portion of a drink can.

A method of the present invention is also presented for balancing and holding an object. The method in the disclosed embodiments substantially includes the steps necessary to carry out the functions presented above with respect to the operation of the described apparatus. In one embodiment, the method includes supplying a base. In one embodiment, the base contains a plane and at least one wall. The method also may include supplying at least one support arm. In another embodiment, the method includes rotatably connecting the at least one support arm to a distal end of the base. The method may also include supplying a basket. In one embodiment of the method, the basket is rotatably connected to the at least one support arm. In one embodiment, the basket includes a face, a bottom, and an open end. The basket may be configured, in one embodiment, to rotate on the at least one support arm such that the bottom and open end are horizontal.

In a further embodiment, the method includes supplying an anchor. In another embodiment, the method includes rotatably connecting the anchor to the base. In one embodiment, the anchor is configured to secure the base to a subsurface.

The method may also include, in one embodiment, attaching at least one gasket to a connection between the basket and the at least one support arm. In one embodiment, the gasket is configured to allow tightening of the connection and securing the basket in a position relative to the at least one support arm. In one embodiment of the method, the basket and the at least one support arm are collapsible against the base.

The method may also include supplying a cover and rotatably connecting the cover to the base and to at least one third support arm. In one embodiment, the cover is configured to cover the basket when the apparatus is in a collapsed position against the base.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of an apparatus to balance and hold an object in accordance with the present invention;

FIG. 1A is a side view illustrating one embodiment of an apparatus to balance and hold an object in accordance with the present invention;

FIG. 2 is a side view illustrating one embodiment of an apparatus to balance and hold an object in accordance with the present invention;

FIG. 3 is a perspective view illustrating one embodiment of an apparatus to balance and hold an object in accordance with the present invention;

FIG. 4 is a perspective view illustrating one embodiment of an apparatus to balance and hold an object in accordance with the present invention;

FIG. 5 is a side view illustrating one embodiment of an apparatus to balance and hold an object in accordance with the present invention;

FIG. 6 is a side view illustrating one embodiment of an apparatus to balance and hold an object in accordance with the present invention;

FIG. 7 is a top view illustrating one embodiment of an apparatus to balance and hold an object in accordance with the present invention;

FIG. 8 is a perspective view illustrating one embodiment of an apparatus to balance and hold an object in accordance with the present invention; and

FIG. 9 is a schematic block diagram illustrating one embodiment of a method to balance and hold an object in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of fasteners, connections, rotational movement, materials, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagram included herein is generally set forth as logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

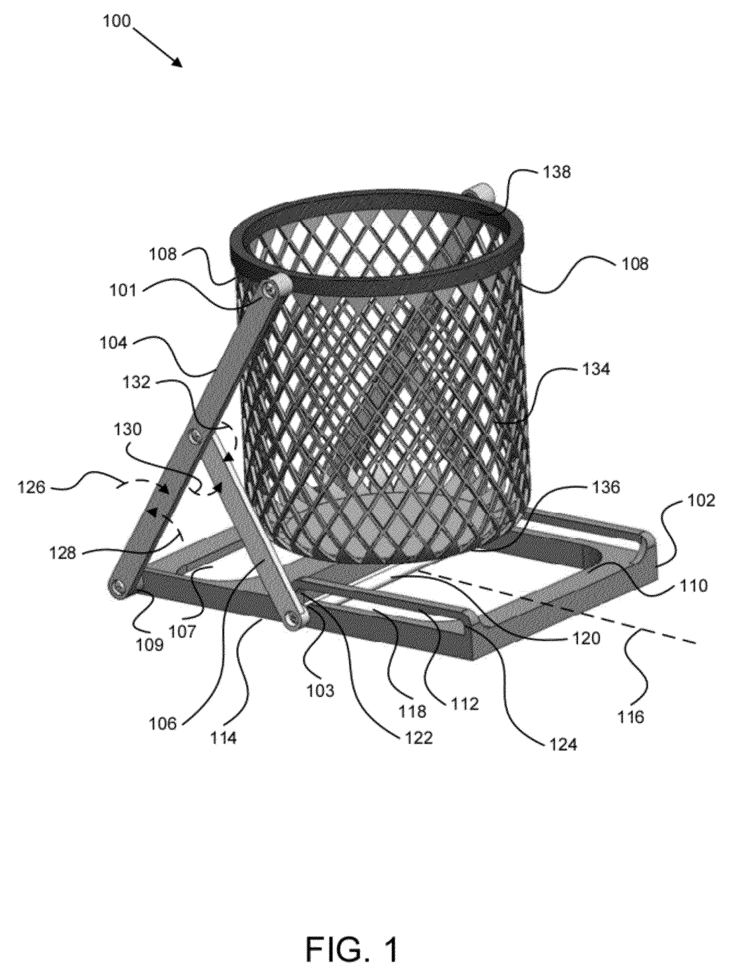

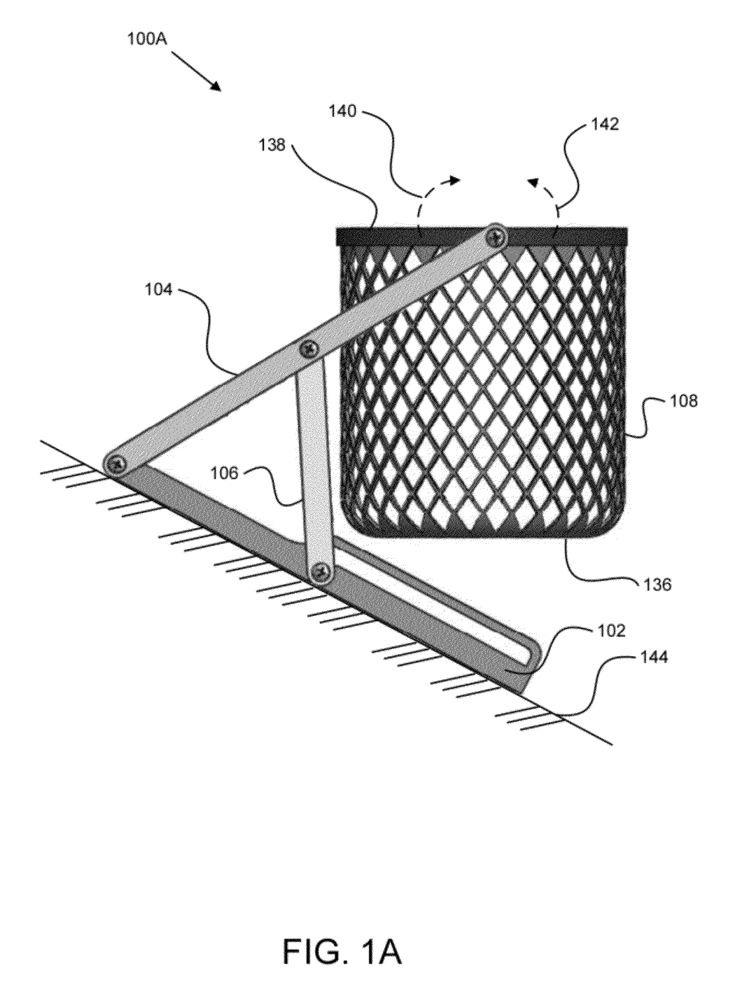

FIG. 1 depicts one embodiment of an apparatus 100 to hold and balance an object. The illustrated apparatus 100 includes a base 102, two support arms 104, two second support arms 106, and a basket 108. Generally, the base 102 supports the apparatus 100 and the support arms 104 and the second support arms 106 support the basket 108. In an upright position (as shown in FIG. 1), the apparatus 100 can receive an item into the basket 108. In one embodiment, the item is a can of soda. In another embodiment, the item is a drinking cup. In another embodiment, the item is a plate. In other embodiments, the object may be a candle, glass bottle, or flag pole. In other embodiments, the basket 108 may be shaped to hold other objects. When the apparatus 100 is in the upright position, the basket 108 is balanced in a horizontal position such that the item in the basket 108 is also in an upright, horizontal position, regardless of the orientation of the base 102.

In one embodiment, the base 102 supports the apparatus 100 and includes a plane 110 and at least one wall 112. In the embodiment of FIG. 1, the base 102 supports the apparatus 100 and includes one plane 110 and two walls 112. In the embodiment of FIG. 1, the two walls 112 are located near opposite external edges 114 of the base 102. In other embodiments, the wall 112 may be located at different positions on the base 102. In one example embodiment, one wall 112 is located along a bisecting line 116 of the plane 110. In another example embodiment, two walls 112 are located near the bisecting line 116 of the plane 110. In yet another example embodiment, the base 102 contains three walls 112 with one wall 112 on the bisecting line 116 of the plane 110 and the other two walls 112 near opposite external edges 114 of the base 102.

In one embodiment, the wall 112 of the base 102 contains a track 118 which is configured to receive a bar 120. In one embodiment, the track 118 is configured to allow the bar 120 to slide within the track 118. In one embodiment, the track 118 is an aperture running parallel with the external edge 114 of the base 102. In the embodiment of FIG. 1, the track 118 contains a locking notch 103. In the embodiment of FIG. 1, the locking notch 103 is located near a center of base 102 and is a declivity in the track 118. In one embodiment, the locking notch 103 holds a bar 120 which is rotatably connected to the second support arm 106. In another embodiment, a ridge performs the function of the locking notch 103 and holds the bar 120 which is rotatably connected to the second support arm 106.

In the embodiment of FIG. 1, the plane 110 extends between the walls 112 of the base 102. In one embodiment, the plane 110 is a flat piece of molded plastic. In another embodiment, the plane 110 contains vacancies 107 to reduce weight and production costs. In the embodiment of FIG. 1, the plane 110 contains two vacancies 107. In one embodiment, the plane 110 is a solid piece without vacancies 107. In another embodiment, the plane 110 contains three vacancies 107. In one embodiment, the plane 110 contains one large vacancy 107 that covers a majority of the surface area of the plane 110.

In one embodiment, the second support arm 106 is connected to the bar 120 while the bar is slidably disposed within the track 118. In one embodiment, the bar 120 is able to slide within the track 118 from a near end 122 of the track 118 to a far end 124 of the track 118. In one embodiment, the bar 120 is configured to lock the apparatus 100 in the upright position when the bar 120 is at the near end 122 of the track. In another embodiment, the bar 120 is configured hold the apparatus 100 in a collapsed position when the bar 120 is at the far end 124 of the track 118.

In one embodiment, the base 102 contains one wall 112 with one track 118. In one embodiment, the one wall 112 with one track 118 is located along a bisecting line 116 of the base 102. In other embodiments, one or more walls 112 each containing a track 118 are located at different positions on the base 102.

In one embodiment, an intersection point between the walls 112 and the base 102 contains a fillet. In one embodiment, a filleted edge increases the strength of the apparatus 100. In one embodiment, the base 102 is one half of one inches thick. In another embodiment, the walls 112 are 0.73 inches tall. In one embodiment, the track 118 is 0.23 inches wide. In different embodiment, the measurements of the base 102, walls 112, and track 118 are different to support different sizes of basket 108. In one embodiment, the thickness of the base 102 varies at different locations of the base 102 to add structural strength and styling.

In the embodiment of FIG. 1, the base 102 is a rectangular shape. In another embodiment, the base 102 is circular shape. In yet another embodiment, the base 102 is an elliptical shape. In another embodiment, the base 102 is a square shape. In other embodiments, the base 102 is made in various shapes that allow for a rotatable connection of at least one support arm 104.

In one embodiment, the base 102 is constructed of molded plastic. In another embodiment, the base 102 is constructed of metal. In another embodiment, the base 102 is constructed of wood. In one embodiment, the base 102, support arms 104, and the second support arms 106 are made of molded plastic.

In one embodiment, the at least one support arm 104 is rotatably connected to the base 102. In the embodiment of FIG. 1, two support arms 104 are rotatably connected to the base 102. In one embodiment, the support arms 104 are rotatably connect to opposite sides of a lateral end of the base 102, as shown in FIG. 1. In one embodiment, the support arms 104 are ¾ of the length of the base 102. In one embodiment, the length of the support arm 104 and the length of the radius of an open end 138 of the basket 108 together are equal to the length of the base 102.

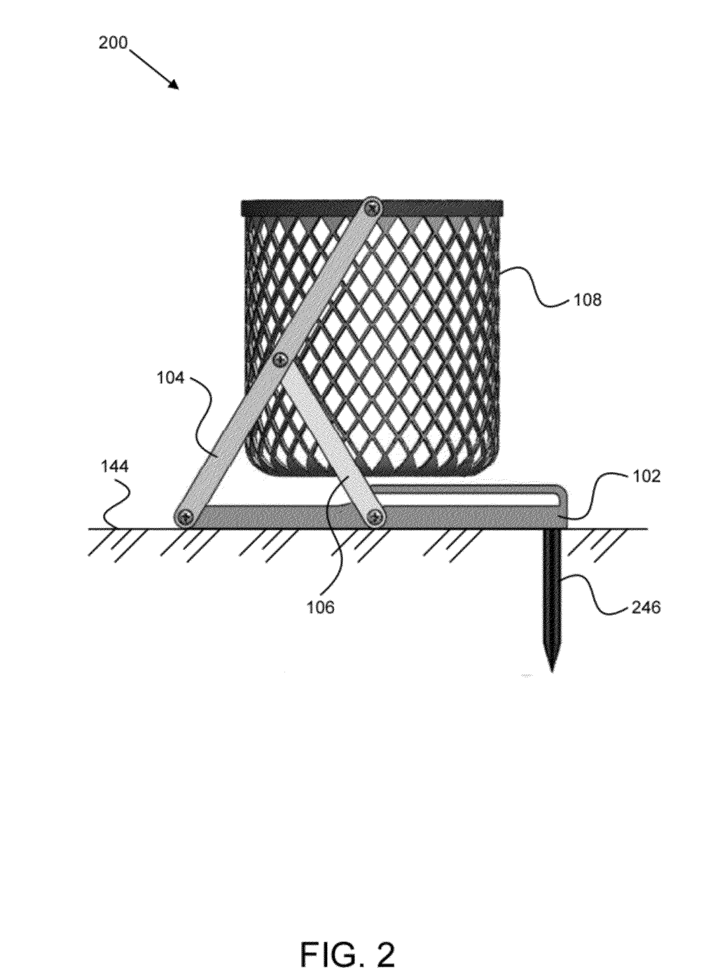

In one embodiment, the support arms 104 contain apertures to allow for rotatable attachment to the base 102 through the use of screws or nails. In the embodiment of FIG. 1, the support arms 104 contain cylindrical extensions 109 at attachment points to the basket 108 and the base 102. In one embodiment, the cylindrical extensions 109 are made of a rubber material. In one embodiment, the cylindrical extensions 109 decrease friction between the basket 108 and the support arms 104 to allow the basket 108 to move in a fifth 140 direction and a sixth 142 direction (see FIG. 2) more easily. In another embodiment, the rotatable connections of the apparatus 100 contain a friction reducing agent to allow the connections rotate more easily.

In the embodiment of FIG. 1, the support arm 104 can rotate in a first direction 126 to move the apparatus 100 towards the collapsed position and can move in a second direction 128 to move the apparatus 100 towards the upright position. In one embodiment, when the support arm 104 rotates in either the first direction 126 or the second direction 128, the second support arm 106 rotates in either the third direction 130 or the fourth direction 132. In order to move the apparatus 100 into the collapsed position, in one embodiment, the support arms 104 rotate in the first direction 126 while the second support arms 106 rotate in the third direction 130. In order to move the apparatus 100 into the upright position, in one embodiment, the support arms 104 rotate in the second direction 128 and the second support arms 106 rotate in the fourth direction 132.

In one embodiment, a rotatable connection is a connection which allows the parts being connected to rotate in at least one dimension with regard to each other. A rotatable connection between the support arm 104 and the base 102 can be accomplished through many methods in different embodiments. In one embodiment, the support arm 104 is rotatably connected to the base 102 through the use of a screw. In other embodiments, the support arm 104 is rotatably connected to the base 102 through the use of a nail, bolt and nut, pin, metal bar, and riveted metal bar. In another embodiment, the rotatable connection between the support arm 104 and the base 102 is accomplished through the use of a mechanism that allows the support arm 104 to rotate in a first 126 and second 128 direction with regard to the base 102.

In one embodiment, the at least one second support arm 106 is rotatably connected to the at least one support arm 104. In the embodiment of FIG. 1, two second support arms 106 are connected to the two support arms 104. In one embodiment, two second support arms 106 are rotatably connected to opposite ends of the bar 120. In one embodiment, the second support arm 106 is rotatably connected to the center of the support arm 104. In another embodiment, the second support arm 106 is rotatably connected to an area below the center of the support arm 104. In another embodiment, the second support arm 106 is rotatably connected to an area above the center of the support arm 104.

In the embodiment of FIG. 1, the two second support arms 106 are also connected, on an opposite end from the connection to the support arms 104, to opposite ends of the bar 120. In one embodiment, the second support arms 106 are connected to opposite distal ends of the bar 120 while the bar 120 is disposed within the track 118 and slides within the track 118.

In one embodiment, a rotatable connection between the support arm 104 and the at least one second support arm 106 is accomplished in the same manner as the rotatable connection between the support arm 104 and the base 102, as described above. In the embodiment of FIG. 1, the second support arms 106 can rotate in a third direction 130 and a fourth direction 132.

In one embodiment, the bar 120 is constructed of metal. In another embodiment, the bar 120 is constructed of a molded plastic material. In one embodiment, the bar 120 is sized to fit within the locking notch 103 of the track 118. In one embodiment, the bar 120 attaches to the second support arm 106 through the use of a screw.

In another embodiment (not shown), the second support arm 106 attaches to a roller that rolls within the track 118 and may be secured within the locking notch 103. In one embodiment, each second support arm 106 attaches to a roller and each roller rolls along the corresponding track 118.

In another embodiment, the second support arm 106 attaches to a short bar that is sized to extend from an outer edge of the wall 112 to the inner edge of the wall 112. Thus, in one embodiment, the short bar only extends a distance sufficient to hold the short bar and the second support arm 106 to the track 118. In one embodiment, as shown in FIG. 1, the bar 120 extends from one side of the base 102 to the opposite side of the base 102.

In one embodiment, the apparatus 100 contains a basket 108 rotatably connected to the at least one support arm 104. In one embodiment, the basket 108 contains a face 134, a bottom 136, and an open end 138. In one embodiment, the face 134 covers the longitudinal length of the basket 108 while the bottom 136 and the open end 138 cover lateral ends of the basket 108. In one embodiment, the open end 138 is open to receive an object within the basket 108 while the bottom 136 is closed to hold the object within the basket 108.

In one embodiment, the basket 108 is a cylindrical shape. In another embodiment, the basket 108 is in a rectangular shape. In another embodiment, the basket 108 is in a conical shape. In other embodiments, the basket 108 is in other shapes that contain a lateral face 134, a bottom 136, and an open end 138.

In the embodiment of FIG. 1, the basket 108 is made of a semi-transparent face 134 and a semi-transparent bottom 136. In one embodiment, the face 134 and the bottom 136 are made of a mesh material. In another embodiment, the basket 108 includes a cloth face 134 and bottom 136. In another embodiment, the basket 108 includes a nylon face 134 and bottom 136. In another embodiment, the basket face 134 and bottom 136 are made of a material that is flexible and can be compacted into a small space. In one embodiment, the basket 108, the support arms 104, and the second support arms 106 are collapsible onto the base 102 by sliding the bar 120 to a far end 124 of the track 118.

In one embodiment, the face 134 of the basket 108 is made of a flexible, compressible material while the bottom 136 of the basket 108 is made of a rigid material. In one embodiment, the rigid material of the bottom 136 helps keep the shape of the basket 108. In another embodiment, the bottom 136 is made of a flexible, compressible material.

In one embodiment, the basket 108 is configured to rotate on the at least one support arm 104 such that the bottom 136 and open end 138 are horizontal. As shown in the embodiment of FIG. 1A, the basket 108 can rotate in a fifth 140 and sixth 142 direction with respect to the support arms 104. Also as shown in FIG. 1A, the basket 108 can rotate such that the bottom 136 and open end 138 are horizontal regardless of the incline of a subsurface 144.

In the embodiment of FIG. 1, the basket 108 is rotatably connected to distal ends 101 of the support arms 104. In one embodiment, the basket 108 is configured to rotate on the support arms 104 such that the bottom 136 is horizontal.

FIG. 2 depicts one embodiment of an apparatus 200 to balance and hold an object that may be substantially similar to the apparatus 100 of FIG. 1. The illustrated apparatus 200 includes a base 102, a support arm 104, a second support arm 106, a basket 108, and an anchor 246. As described generally above, in one embodiment, the base 102 supports the apparatus 200 and the support arms 104 and the second support arms 106 support the basket 108. In an upright position (as shown in FIG. 2), the apparatus 200 can receive an item into the basket 108. When in the apparatus 200 is in the upright position, the basket 108 is balanced in a horizontal position such that the item in the basket 108 is also in an upright, horizontal position, regardless of the orientation of the base 102.

In one embodiment, the apparatus 200 includes an anchor 246 which is configured to secure the apparatus 200 to a subsurface 144. In the embodiment of FIG. 2, the anchor 246 is a spike which is configured to penetrate the subsurface 144. In one embodiment, the anchor 246 is a metal bar with a barb disposed on a far end of the metal bar. In one embodiment, the anchor 246 is a bar with ridges disposed along the length of the bar. In one embodiment, the anchor 246 is a screw shaped metal bar. In one embodiment, the anchor 246 is a plastic bar. In other embodiments, the anchor 246 is any mechanism used to secure the apparatus 100 to the subsurface 144.

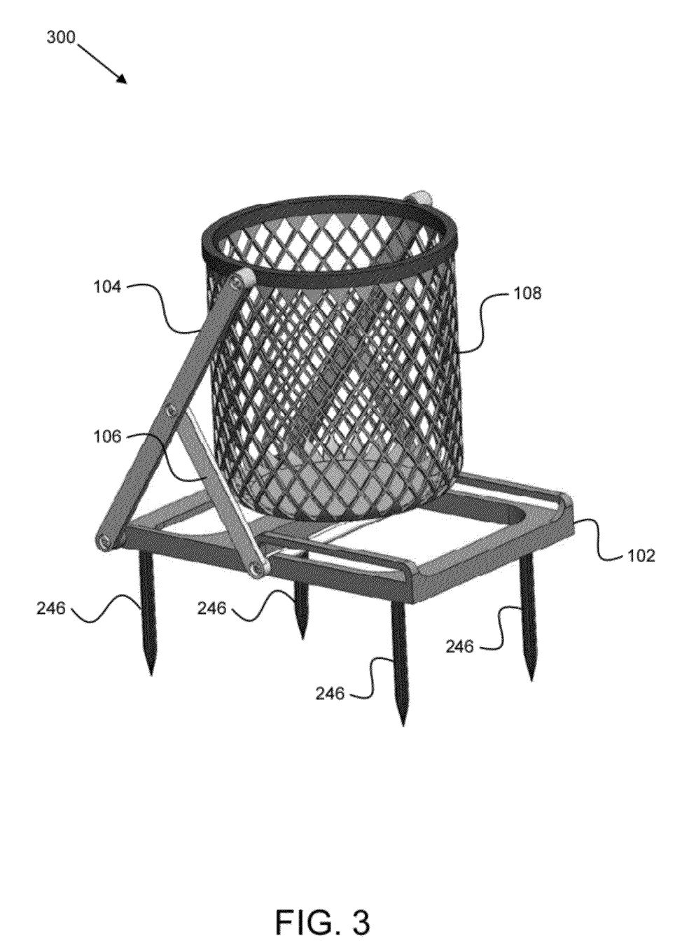

FIG. 3 depicts one embodiment of an apparatus 300 to balance and hold an object that may be substantially similar to the apparatus 100 of FIG. 1. The illustrated apparatus 300 includes a base 102, two support arms 104, two second support arms 106, a basket 108, and four anchors 246. As described generally above, the base 102 supports the apparatus 300 and the support arms 104 and the second support arms 106 support the basket 108. In an upright position (as shown in FIG. 3), the apparatus 300 can receive an item into the basket 108. When in the apparatus 300 is in the upright position, the basket 108 is balanced in a horizontal position such that the item in the basket 108 is also in an upright, horizontal position, regardless of the orientation of the base 102. The anchors 246 secure the apparatus 300 to the subsurface 144.

In the embodiment of FIG. 3, the base 102 contains four anchors 246. In the embodiment of FIG. 3, the anchors 246 are located in corners of the rectangular base 102. In another embodiment, a single anchor 246 is located in the center of the base 102. In other embodiments, any number of anchors 246 may be placed in any orientation on the base 102 to secure the apparatus 300 to the subsurface 144. In one example embodiment, the base 102 contains three anchors 246. In yet another example embodiment, the base 102 contains five anchors 246.

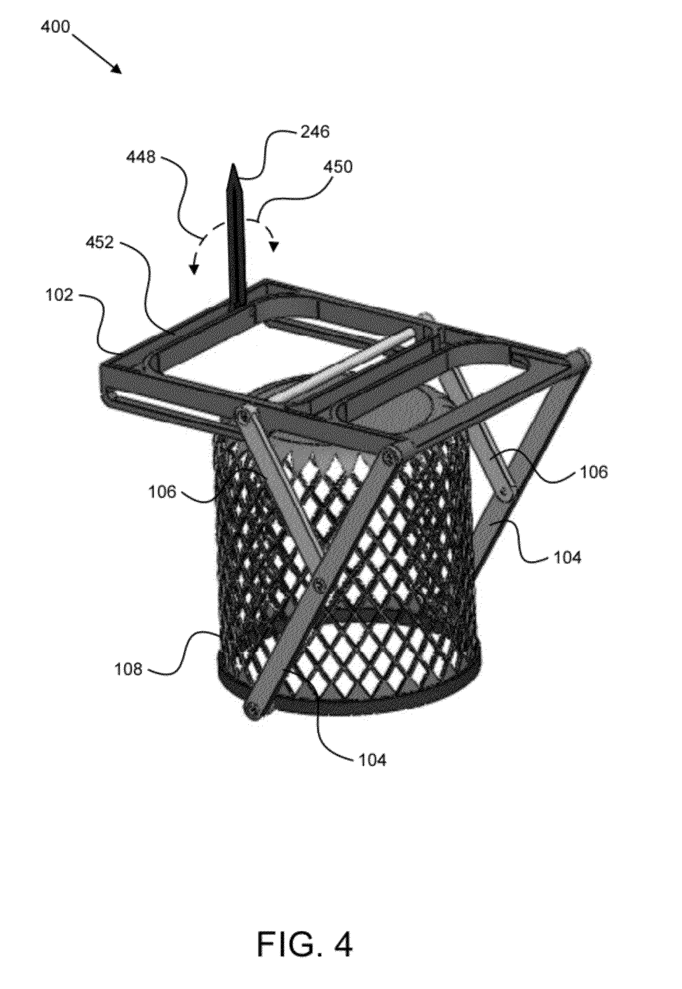

FIG. 4 depicts one embodiment of an apparatus 400 to balance and hold an object that may be substantially similar to the apparatus 100 of FIG. 1. The illustrated apparatus 400 includes a base 102, two support arms 104, two second support arms 106, a basket 108, and an anchor 246. As described generally above, the base 102 supports the apparatus 400 and the support arms 104 and the second support arms 106 support the basket 104. The base 102 contains an anchor 246 that is configured to secure the apparatus 400 to the subsurface 144.

In one embodiment, the anchor 246 is rotatably connected to the base 102. In the embodiment of FIG. 4, the anchor 246 can rotate in a seventh direction 448 toward the base and can rotate in an eighth direction 450 away from the base 108. In one embodiment, the base 102 also contains a locking chamber 452. In one embodiment, the locking chamber 452 is configured to hold the anchor 246 when the anchor 246 is rotated toward the base 102 and touches the base 102. In one embodiment, the locking chamber 452 holds the anchor 246 so that the apparatus 400 can be safely transported. In one embodiment, the anchor 246 locks into the locking chamber 452 through the use of a friction fit. In another embodiment, the anchor 246 is held within the locking chamber 452 due to the friction at the rotatable connection between the base 102 and the anchor 246.

In one embodiment, the base 102 contains several anchors 246 and a corresponding number of locking chambers 452 disposed in the base 102. In this embodiment, each anchor 246 corresponds to a locking chamber 452 so that each anchor 246 can be secured to the base 102.

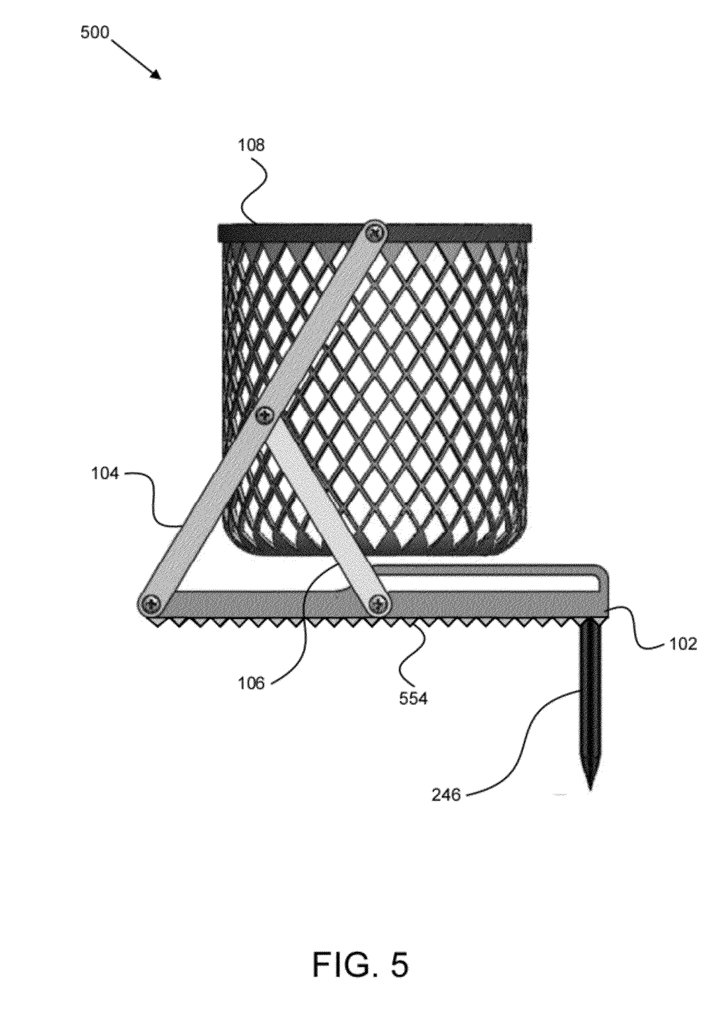

FIG. 5 depicts one embodiment of an apparatus 500 to balance and hold an object that may be substantially similar to the apparatus 100 of FIG. 1. The illustrated apparatus 500 includes a base 102, a support arm 104, a second support arm 106, a basket 108, an anchor 246, and ribs 554. As described generally above, the base 102 supports the apparatus 500 and the support arms 104 and the second support arms 106 support the basket 108. In one embodiment, the base 102 contains an anchor 246 that is configured to secure the apparatus 500 to the subsurface 144.

In another embodiment, the base 102 also contains ribs 554 configured to grip to the subsurface 144. In the embodiment of FIG. 5, the base 102 contains ribs 554 and an anchor 246 to secure the apparatus 500 to a subsurface 144. In the embodiment of FIG. 5, the base 102 contains ribs 554 located along an outer edge of the base 102. In another embodiment, an entire bottom side of the base 102 is covered in ribs 554.

In another embodiment, the base 102 contains adhesive to secure the base 102 to the subsurface 144. In one example embodiment, the base 102 is secured to an interior surface of an automobile through the use of an adhesive. In another example, the base 102 is secured to an interior surface of a boat through the use of an adhesive. In another embodiment, the base is secured to a subsurface through the use of a suction device.

In another embodiment, the base 102 contains one half of a locking mechanism. The other half of the locking mechanism is located on the subsurface to which the base is to be secured. In one example embodiment, the male portion of a snap button is located on the base 102 and the female portion of the button is located on the subsurface to which the base 102 is to be secured. In another example embodiment, the base 102 contains a clip and the subsurface contains a corresponding clip ring.

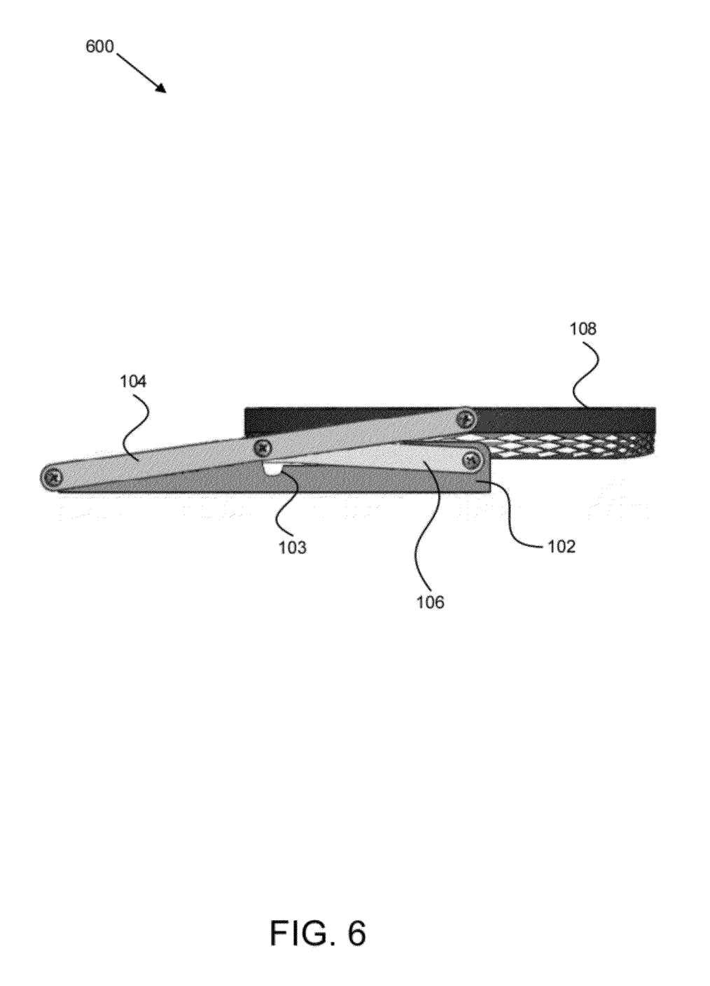

FIG. 6 depicts one embodiment of an apparatus 600 to balance and hold an object that may be substantially similar to the apparatus 100 of FIG. 1. The illustrated apparatus 600 includes a base 102, two support arms 104, two second support arms 106, and a basket 108. As described generally above, the base 102 supports the apparatus 600 and the support arms 104 and the second support arms 106 support the basket 108. In one embodiment, the support arms 104 are rotatably connected to the base 102 and the second support arms 106 are rotatably connected to the support arms 104. In one embodiment, the wall 112 of the base 102 contains a track 118. In one embodiment, the track 118 is an aperture running parallel with the external edge 114 of the base 102. In one embodiment, the at least one second support arm 106 is connected to a bar 120 which is slidably disposed within the track 118. In one embodiment, the bar 120 is able to slide within the track 118 from a near end 122 of the track 118 to a far end 124 of the track 118. In one embodiment, the bar 120 is configured to lock the apparatus 600 in the upright position when the bar 120 is at the near end 122 of the track 118. In one embodiment, the bar 120 is configured hold the apparatus 600 in a collapsed position when the bar 120 is at the far end 124 of the track 118.

In the embodiment of FIG. 6, the apparatus 600 is in the collapsed position. In one embodiment, the at least one support arm 104, the second support arm 106, and the basket 108 collapse into and substantially flatten against the base 102. In one embodiment, the basket 108 is made of a material that allows it to be substantially flattened against the base 102.

In one embodiment, the track 118 contains a locking notch 103 to hold the bar 120 when the second support arm 106 is moved to the near end 122 of the track 118. When the bar 120 is moved to the far end 124 of the track 118, as shown in FIG. 6, the apparatus 600 is in the collapsed position.

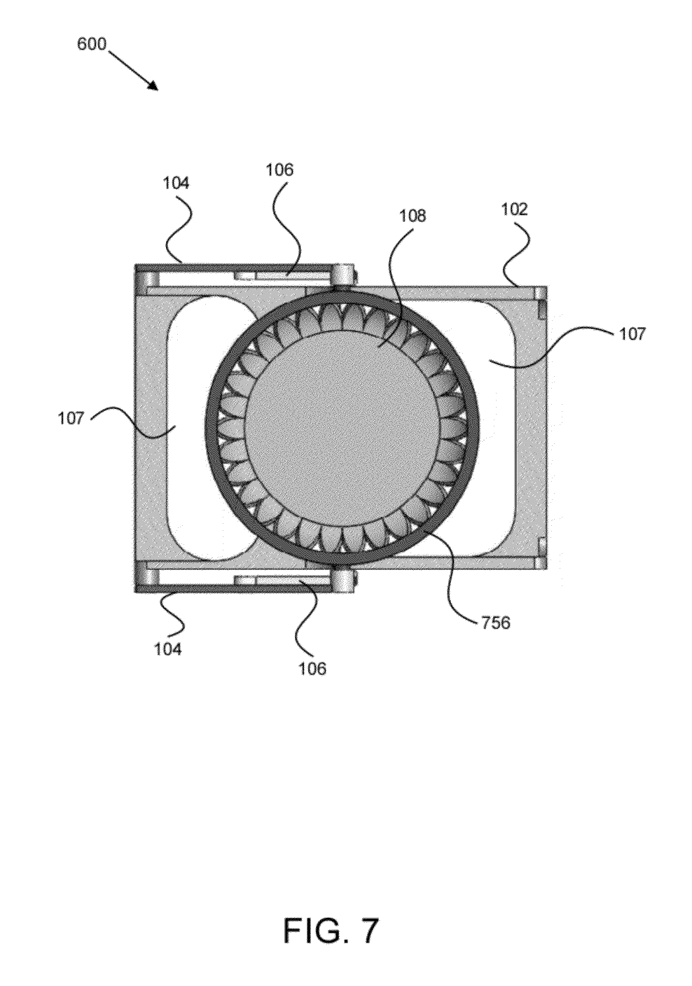

FIG. 7 depicts one embodiment of an apparatus 700 to balance and hold an object that may be substantially similar to the apparatus 100 of FIG. 1. The illustrated apparatus 700 includes a base 102, two support arms 104, two second support arms 106, a basket 108, and a shape-keeping ring 756. As described generally above, the base 102 supports the apparatus 700 and the support arms 104 and the second support arms 106 support the basket 108. The basket 108 may be configured to contain any number of a plurality of objects of different shapes and sizes.

In one embodiment, the basket 108 includes a shape-keeping ring 756. In one embodiment, the shape-keeping ring 576 is disposed on a top portion of the basket 108. In the embodiment of FIG. 7, the shape-keeping ring 756 is configured to maintain a circular shape of the top portion of the basket 108. In one embodiment, the basket 108 is made of a flexible material such that the shape-keeping ring determines the shape of the basket. In one embodiment, the shape-keeping ring 756 helps the basket 108 keep a cylindrical shape when it is attached to the top portion of the basket 108. In one embodiment, the basket 108 is held in a cylindrical shape by the shape-keeping ring 756 such that the basket 108 may contain a lower portion of a drink can.

In one embodiment, the bottom 136 of the basket 108 is made of a semi-rigid material such that the bottom 136 of the basket 108 also helps keep the shape of the basket 108 along with the shape-keeping ring 756. In one example embodiment, the shape-keeping ring 756 is circular and the bottom 136 of the basket 108 is rigid and circular such that both the shape-keeping ring 756 and the bottom 136 help keep the shape of the basket 108.

In another embodiment, the basket 108 contains a rectangular shape-keeping ring 756. In this embodiment, the basket 108 is made of a flexible material and the rectangular shape-keeping ring 756 helps the basket 108 keep a rectangular shape when it is attached to the top portion of the basket 108. In other embodiments, the shape-keeping ring 756 may be in any shape to keep the basket 108 in that shape.

In one embodiment, the shape-keeping ring 756 is a metal wire. In another embodiment, the shape-keeping ring 756 is made of molded plastic. In one embodiment, the basket 108 contains several shape-keeping rings 756 disposed along the face 134 of the basket 108. In one embodiment, a single, spring-loaded shape-keeping ring 756 extends along the face 134 of the basket 108.

In one embodiment, the base 102 contains at least one vacancy 107. In the embodiment of FIG. 7, the base 102 contains two vacancies 107. In one embodiment, the vacancies 107 lower the weight of the apparatus 700 and decrease the cost of materials.

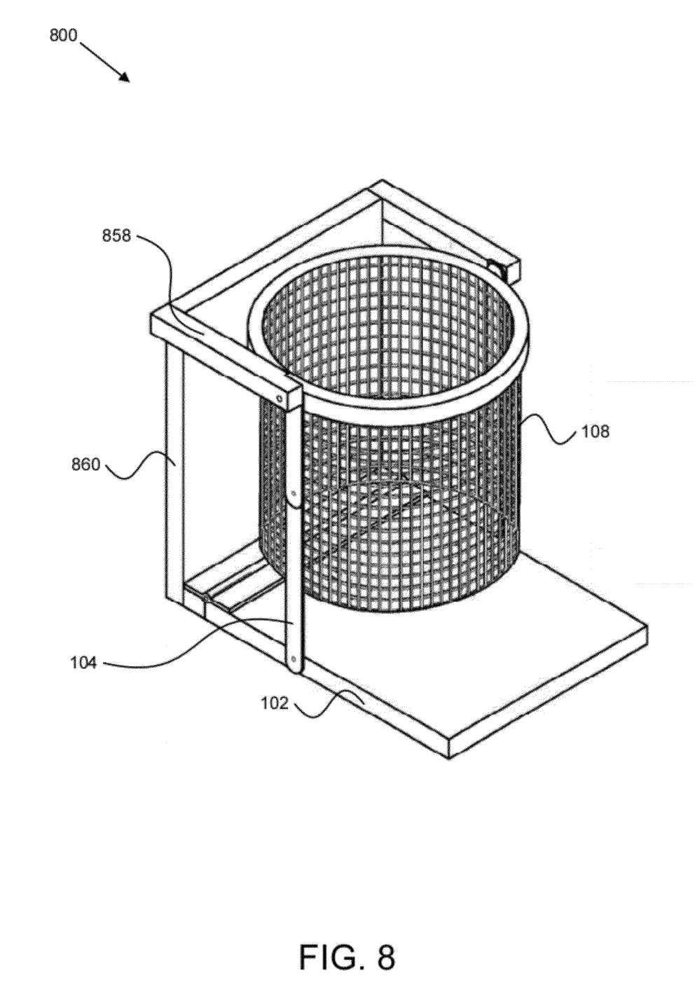

FIG. 8 depicts one embodiment of an apparatus 800 to balance and hold an object that may be substantially similar to the apparatus 100 of FIG. 1. The illustrated apparatus 800 includes a base 102, two support arms 104, two third support arms 858, a basket 108, and a cover 860. As described generally above, the base 102 supports the apparatus 800 and the support arms 104 support the basket 108. The basket 108 may be configured to contain any number of a plurality of objects of different shapes and sizes. In one embodiment, the basket 108 and the support arms 104 can be oriented in a collapse position against the base 102.

In one embodiment, a cover 860 is rotatably attached to the base 102 and the third support arms 858. In one embodiment, the third support arms 858 are attached to the basket 108 on one lateral end and to the cover 860 on the other lateral end. In one embodiment, the cover 860 is configured to cover the basket 108 when the apparatus 800 is in the collapsed position against the base 102. In one embodiment, the cover 860 is made of the same material as the base 102 and the support arms 104. In the embodiment of FIG. 8, the support arms 104 are made of two sections that are rotatably connected to each other. The rotatable connections between the two sections of the support arms 104, the third support arms 858, the cover 860, and the base 102 allow the apparatus 800 to move into the collapsed position.

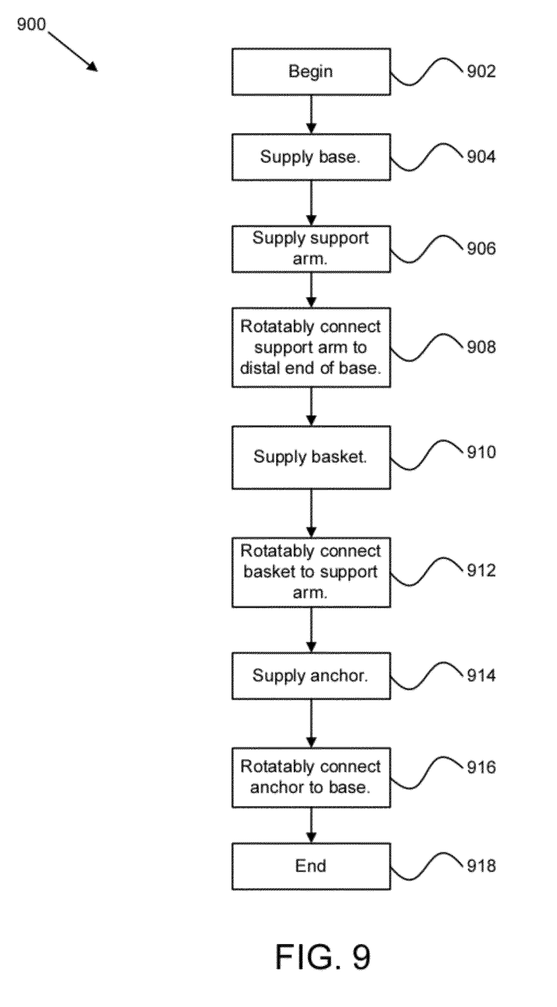

FIG. 9 depicts one embodiment of a method 900 to balance and hold an object. In the illustrated method 900, the method 900 begins 902 and a base 102 is supplied 904. In one embodiment, the base 102 contains a plane 110 and at least one wall 112. At least one support arm 104 is supplied 906. The at least one support arm 104 is rotatably connected 908 to a distal end of the base 102. A basket 108 is supplied 910. The basket 108 is rotatably connected 912 to the at least one support arm 104. In one embodiment, the basket 108 contains a face 134, a bottom 136, and an open end 138. In another embodiment, the basket 108 is configured to rotate on the at least one support arm 104 such that the bottom 136 and open end 138 are horizontal. An anchor 246 is supplied 914. The anchor 246 is rotatably connected 916 to the base 102. In one embodiment, the anchor 246 is configured to secure the base 102 to a subsurface 144. The method ends 918.

In one embodiment, the method 900 includes attaching at least one gasket to a connection between the basket 108 and the at least one support arm 104. In one embodiment, the gasket allows tightening of the connection and securing the basket 108 in a position relative to the at least one support arm 104. In another embodiment, the basket 108 and the at least one support arm 104 are collapsible against the base 102.

In another embodiment, the method 900 includes supplying a cover 860 and rotatably connecting the cover 860 to the base 102 and the third support arm 104. In one embodiment, the cover 860 is configured to cover the basket 102 when the apparatus 100 is in a collapsed position against the base 102. In another embodiment, the method 900 includes supplying at least two anchors 246 and rotatably securing the at least two anchors 246 to the base.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to balance and hold an object, the apparatus comprising:
a base configured to support the apparatus, wherein the base comprises a plane and at least one wall;
at least one support arm rotatably connected to the base; and
a basket rotatably connected to the at least one support arm, wherein the basket comprises a face, a bottom, and an open end, wherein the basket is configured to rotate on the at least one support arm such that the bottom and open end are horizontal.

2. The apparatus of claim 1, further comprising at least one second support arm rotatably connected to the at least one support arm;

3. The apparatus of claim 1, further comprising an anchor connected to the base, wherein the anchor is configured to secure the apparatus to a subsurface.

4. The apparatus of claim 3, wherein the anchor comprises a spike, wherein the spike is configured to penetrate the subsurface.

5. The apparatus of claim 3, wherein two or more anchors are connected to the base.

6. The apparatus of claim 3, wherein the anchor is rotatably connected to the base, wherein the base further comprises a locking chamber configured to hold the anchor when the anchor is rotated toward the base.

7. The apparatus of claim 1, wherein the base comprises ribs configured to grip to a subsurface.

8. The apparatus of claim 1, wherein the basket further comprises a semi-transparent face and a semi-transparent bottom.

9. The apparatus of claim 8, wherein the face and the bottom comprise a mesh material.

10. The apparatus of claim 1, wherein the at least one support arm and the basket collapse onto and substantially flatten against the base.

11. The apparatus of claim 1, wherein the wall of the base comprises a track and wherein the at least one second support arm is connected to a bar which is slidably disposed within the track, wherein the bar is configured to lock the apparatus in an upright position when the bar is at a near end of the track and wherein the bar is configured to hold the apparatus in a collapsed position when the bar is at a far end of the track.

12. The apparatus of claim 1, wherein the basket further comprises a shape-keeping ring disposed on a top portion of the basket, wherein the shape-keeping ring is configured to maintain a circular shape of the top portion of the basket.

13. An apparatus to balance and hold an object, the apparatus comprising:
a base configured to support the apparatus, wherein the base comprises a plane and at least one wall, wherein the at least one wall comprises a track;
two support arms rotatably connected to opposite ends of the base;
two second support arms rotatably connected to the two support arms and connected to opposite distal ends of a bar, wherein the bar is disposed within the track and slides within the track;
a basket rotatably connected to a distal ends of the support arms, wherein the basket comprises a face and a bottom, wherein the basket is configured to rotate on the support arms such that the bottom is horizontal, wherein the basket and the support arms are collapsible onto the base by sliding the bar to a far end of the track.

14. The apparatus of claim 13, wherein the base comprises at least one vacancy.

15. The apparatus of claim 13, wherein the base, the support arms, and the second support arms comprise molded plastic.

16. The apparatus of claim 13, wherein the basket is cylindrical and is configured to contain a lower portion of a drink can.

17. A method to balance and support an object, the method comprising:
supplying a base, wherein the base comprises a plane and at least one wall;
supplying at least one support arm;
rotatably connecting the at least one support arm to a distal end of the base;
supplying a basket;
rotatably connecting the basket to the at least one support arm, wherein the basket comprises a face, a bottom, and an open end, wherein the basket is configured to rotate on the at least one support arm such that the bottom and open end are horizontal;
supplying an anchor; and
rotatably connecting the anchor to the base, wherein the anchor is configured to secure the base to a subsurface.

18. The method of claim 17, wherein the method comprises attaching at least one gasket to a connection between the basket and the at least one support arm, wherein the gasket is configured to allow tightening of the connection and securing the basket in a position relative to the at least one support arm.

19. The method of claim 17, wherein the basket and the at least one support arm are collapsible against the base.

20. The method of claim 17, further comprising supplying a cover and rotatably connecting the cover to the base and to at least one third support arm, wherein the cover is configured to cover the basket when the apparatus is in a collapsed position against the base.
